(19) United States
(12) Patent Application Publication
(10) Pub. No.: US 2026/0091492 A1
(43) Pub. Date: Apr. 2, 2026

(54) ROBOT END EFFECTOR FOR SURFACE TREATMENT OF SOFT MATERIALS AND METHOD FOR CONTROLLING ROBOT HAVING THE SAME

(71) Applicant: Openpath Robotics, Co., Ltd., Busan (KR)

(72) Inventors: Hyeon Je CHA, Busan (KR); Ho Sun KANG, Busan (KR); Young Woo KWON, Busan (KR)

(21) Appl. No.: 19/331,963

(22) Filed: Sep. 17, 2025

(30) Foreign Application Priority Data
Sep. 27, 2024 (KR) 10-2024-0131415
Sep. 4, 2025 (KR) 10-2025-0125492

(51) Int. Cl. B25J 9/16; A43D 11/00

(52) U.S. Cl. CPC B25J 9/1633; A43D 11/00

(57) ABSTRACT

The present disclosure relates to a robot end effector for treating a surface of soft materials, and the end effector may include a coupler coupled to a tool flange of the robot; a motor coupled to the coupler to have a rotation axis orthogonal to a rotation axis of the tool flange; and a work tool connected to the motor to rotate according to the rotation of the motor, wherein the motor has a gear ratio lower than that of the motor provided in the robot.

### BACKGROUND OF THE INVENTION

### Cross-Reference to Related Application

This application claims priority under 35 U.S.C § 119 to Korean Patent Application No. 10-2024-0131415 filed in the Korean Intellectual Property Office on Sep. 27, 2024, and Korean Patent Application No. 10-2025-0125492 filed in the Korean Intellectual Property Office on Sep. 4, 2025, the entire contents of which are hereby incorporated by reference.

### FIELD OF THE INVENTION

The present disclosure relates to an end effector of a robot for treating a surface of an object made of a soft material such as leather or rubber.

### BACKGROUND OF THE RELATED ART

A robot refers to a machine that automatically processes or operates tasks given by its own ability, and the application fields of robots may be classified into industrial, service, medical, space, and submarine.

Among them, an industrial robot is applied to industrial automation, which is an automatically controlled and reprogrammable multipurpose manipulator, refers to a robot that can be programmed in three or more axes and can be stationary or mobile, and may include hand-guided robots, manipulator parts of mobile robots, and collaborative robots.

Meanwhile, in addition to an industrial robot as described above, an industrial robot system may be configured to include an end device, and all machines, equipment, devices, additional axes, or sensors required for the robot to perform work.

The industrial robot system is already widely operated in machining industries such as automobile manufacturing to repeat a motion corresponding to the work performed by a human arm, and in recent years, its utilization is increasing due to factors such as rising labor costs.

Meanwhile, the industrial robot is also used in a process of treating a surface of an object, such as buffing, by attaching a specific tool to the end.

The buffing process refers to the work of polishing and evening the surface of various materials using sand paper or creating roughness on the surface of the material, and for example, in the case of a leather fabric material, the leather surface is made even through buffing, and in the case of a shoe upper material, a certain part of the upper surface may be roughened to increase an adhesive strength between the upper and the shoe sole.

In the case of a conventional buffing process using an industrial robot, there is an inconvenience in that a user has to directly teach a buffing path, and there is a problem in that the surface treatment is not uniform because it is difficult to precisely control the force.

### SUMMARY OF THE INVENTION

The technical problem to be solved by the present disclosure is to provide a robot end effector that can improve usability by overcoming problems caused by the precision of a robot system in treating a surface of soft materials using a robot and a method of controlling a robot including the same.

In order to solve the foregoing problem, a robot end effector according to an embodiment of the present disclosure may include a coupler coupled to a tool flange of the robot; a motor coupled to the coupler to have a rotation axis orthogonal to a rotation axis of the tool flange; and a work tool connected to the motor to rotate according to the rotation of the motor, wherein the motor has a gear ratio lower than that of the motor provided in the robot.

The motor may be a direct drive (DD) motor or a quasi direct drive (QDD) motor.

Meanwhile, the end effector may be controlled so as to allow a torque of the motor to maintain a preset torque range.

A robot control method according to an embodiment of the present disclosure, which is a method of controlling a robot including the end effector and a robot arm, may include scanning a shape of a soft material object to be surface-treated to extract work points on a surface of the object; configuring a path of the robot arm based on the extracted work points; operating the work tool included in the end effector to treat the surface of the object while moving the robot arm along the configured path; and controlling a torque of the motor included in the end effector to maintain a preset torque range while the work tool is in operation.

The path of the robot arm may be configured such that a longitudinal vector of the work tool and a normal vector of the work point can be orthogonal to each other and a rotation axis of the motor and the normal vector can be orthogonal to each other for the extracted work points.

At least part of the robot control method may be implemented as a computer-readable recording medium in which a program for executing a computer is recorded, and may be provided as the program itself.

Meanwhile, the robot control method may be performed by a robot according to an embodiment of the present disclosure.

According to an embodiment of the present disclosure, a robot end effector for surface treatment may be configured by using a direct drive motor having a low gear ratio or no gear, and a torque of the motor may be controlled to maintain a preset torque range, thereby improving precision and uniformity of soft material surface treatment using a robot.

In addition, through an end effector and controlling of a force of the end effector according to an embodiment of the present disclosure, it may overcome a position information error of a robot arm path due to precision of a vision sensor, a position information error due to precision of a collaborative robot, and a position information error of the robot arm path due to coordinate conversion between the vision sensor and the collaborative robot.

### BRIEF DESCRIPTION OF THE DRAWINGS

FIG. 1 is a drawing for explaining one embodiment of a surface treatment process according to the present disclosure.

FIG. 2 is a perspective view showing a configuration of a robot according to one embodiment of the present disclosure.

FIG. 3 is a perspective view showing an overall configuration of a robot end effector according to one embodiment of the present disclosure.

FIG. 4 is a perspective view for explaining one embodiment of a configuration of a robot end effector.

FIG. 5 is a flowchart showing a robot control method according to one embodiment of the present disclosure.

FIGS. 6 to 9 are drawings for explaining embodiments of a method of performing a buffing process according to the robot control method of the present disclosure.

### DETAILED DESCRIPTION OF THE PREFERRED EMBODIMENT

The following description illustrates the principles of the present disclosure. It will thus be appreciated that those skilled in the art will be able to devise various devices that, although not explicitly described or illustrated in this specification, implement the principles of the present disclosure and are included in the concept and scope of the present disclosure. Furthermore, it should be understood that all conditional terms and embodiments recited in this specification are intended only for pedagogical purposes to aid the reader in understanding the concept of the present disclosure, and are not limited to such specifically recited embodiments and conditions.

Moreover, it should be understood that all detailed description herein reciting the principles, aspects, and embodiments of the present disclosure as well as specific embodiments thereof are intended to encompass both structural and functional equivalents thereof. Additionally, it should be understood that such equivalents include both currently known equivalents as well as equivalents to be developed in the future, that is, any elements developed to perform the same function regardless of its structure.

Thus, for example, it should be understood that the block diagrams presented herein represent the conceptual view of an exemplary circuit that embodies the principles of the present disclosure. Similarly, it should be understood that any flow charts, flow diagrams, state transition diagrams, pseudocodes, and the like represent various processes which may be substantially represented in computer readable media and so executed by a computer or processor, whether or not such a computer or processor is explicitly illustrated.

The functions of various elements including a processor or a functional block represented as a concept similar thereto and illustrated in the accompanying drawings may be provided using hardware having a capability to execute appropriate software as well as dedicated hardware. When provided by the processor, the functions may be provided by a single dedicated processor, a single shared processor, or a plurality of individual processors, and some thereof may be shared with one another.

In addition, it should be understood that explicit use of the terms presented as processors, controls, or concepts similar thereto should not be interpreted by exclusively quoting hardware having an ability of executing software, and should be understood to implicitly include, without limitation, digital signal processor (DSP) hardware, and a ROM, a RAM and a non-volatile memory for storing software. Other known common hardware may also be included.

In the claims of this specification, an element expressed as a means for performing a function described in the detailed description is intended to include, for example, any method of performing a function including a combination of circuit elements or any form of software including firmware/microcode, and the like, which perform the function, and is combined with suitable circuitry for executing the software to perform the function. It should be understood that since functions provided by the various recited means are combined with one another and are combined with a scheme demanded by the claims in the present disclosure defined by the claims, any means capable of providing these functions are equivalent to means recognized from this specification.

The foregoing objects, features and advantages will be more obvious through the following detailed description associated with the accompanying drawings, and accordingly, the technological concept of the present disclosure may be easily implemented by a person having ordinary skill in the art to which the present disclosure pertains. In describing the present disclosure, moreover, the detailed description will be omitted when a specific description for publicly known technologies to which the present disclosure pertains is judged to obscure the gist of the present disclosure.

Hereinafter, embodiments of the present disclosure will be described using a collaborative robot as an example, but the present disclosure is not limited thereto, and can be applied to various robots including industrial robots.

The collaborative robot is a robot designed to interact directly with a human within a defined collaborative workspace, while a collaborative operation may refer to a working state between a robot system and an operator intentionally designed within a collaborative workspace.

Additionally, the collaborative workspace is a workspace within a safeguarded space where a robot and a human perform work simultaneously during a manufacturing operation, which may refer to a space within a workspace where a robot system (including a workpiece) and a human can perform work simultaneously during manufacturing work.

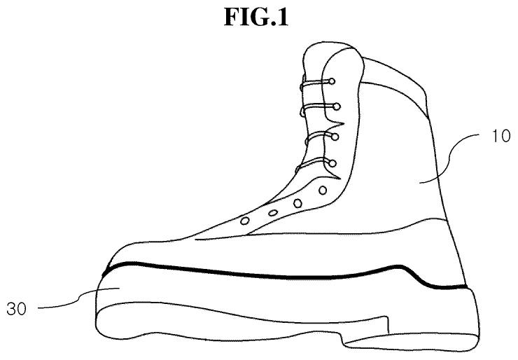

FIG. 1 is a view for explaining one embodiment of a surface treatment process according to the present disclosure, which is an example of a process for treating a surface of an object made of a soft material using a robot to explain a buffing process during a shoe manufacturing process.

Referring to FIG. 1, a shoe-making process of assembling an upper 10 and a sole 30 of a shoe may include a gaging process of holding a line for a portion where the sole 30 is joined to the upper 10, and a buffing process of roughly grinding a surface of the upper 10 along a joining line drawn in the gaging process.

According to one embodiment of the present disclosure, in treating a surface of soft materials, such as a buffing process during a shoe-making process, a robot end effector may be configured using a direct drive (DD) motor having a low gear ratio or no gear, and a torque of the motor may be controlled to maintain a preset torque range, thereby improving the precision and uniformity of surface treatment using a robot.

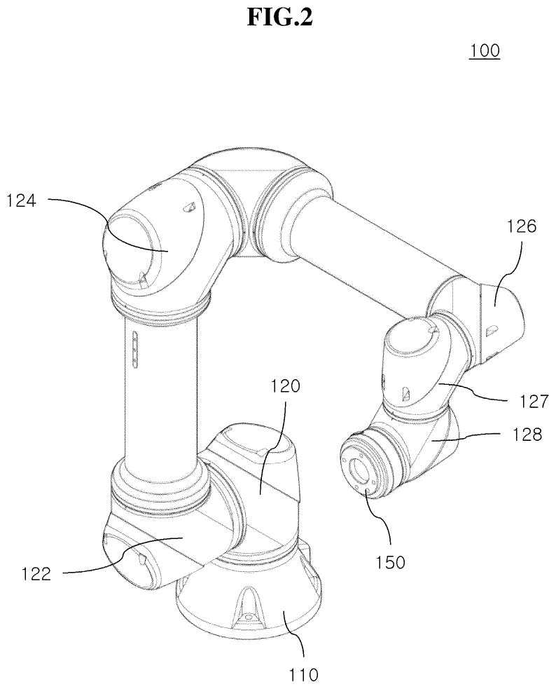

FIG. 2 illustrates a configuration of a robot according to one embodiment of the present disclosure, wherein the robot 100 may be configured to include a base 110, a plurality of joints 120 to 128, and a tool flange 150.

Referring to FIG. 2, the base 110 is a part for fixing the robot 100, and a cable connection connector between the robot 100 and the control box may be disposed on the base 110.

The tool flange 150 is a part that mounts a gripper or tool on the robot 100, and input/output ports for controlling the gripper or tool and buttons for direct teaching may be arranged at positions adjacent to the tool flange 150.

Meanwhile, between the base 110 and the tool flange 150, a base joint 120, a shoulder joint 122, an elbow joint 124, a first wrist joint 126, a second wrist joint 127, and a third wrist joint 128 may be provided so as to enable a six-axis joint motion of the robot 100.

The robot 100 having a structure as described with reference to FIG. 2 may enable a cooperative operation, and the cooperative operation may include one or more of safe monitored stop, hand guiding, speed and position monitoring, and power and force limiting (PFL).

In the safe monitored stop method, a safe monitored stop function is used to stop the robot's motion before an operator enters a collaborative workspace to interact with a robot system and complete work.

When there is no operator in the collaborative workspace, the robot 100 operates non-cooperatively, and an operator is allowed to enter the collaborative workspace when the safe monitored function is activated to stop the robot's motion while the robot system is present in the collaborative workspace. Meanwhile, after the operator leaves the collaborative workspace, the robot system's movement may resume without further intervention.

In the hand guiding method, the operator uses a hand-operated device to transmit a motion command to the robot system, and the robot 100 must complete safe monitored stop before the operator is permitted to enter the collaborative workspace and perform hand guiding work.

The work is performed by manually operating guiding devices positioned at or near the robot's end device, and the robot system used for hand guiding must have additional functions such as force output, virtual safety zones or tracking technology.

In the speed and position monitoring method, the robot system and the operator are allowed to move simultaneously in the collaborative workspace, and risk reduction may be achieved by maintaining a minimum protective separation distance between the operator and the robot 100.

In this case, while the robot 100 is operating, a distance between the robot system and the operator must never become closer than a protective separation distance, and the robot system stops when the separation distance decreases to a value smaller than the protective separation distance. Meanwhile, the robot system may automatically resume an operation while maintaining a minimum protective separation distance when the operator moves away from the robot system, and the protective separation distance may decrease simultaneously when the robot system slows down.

In an operation mode according to the power and force limiting (PFL) method, a physical contact between the robot system (including a workpiece) and the operator may occur intentionally or unintentionally, and a collaborative operation with limited power and force requires a robot system designed for this specific type of operation.

In this case, a risk may be reduced by managing a risk source associated with the robot system below an allowable limit determined in a risk assessment process through a robot or safety-rated control system that includes fundamental safety measures, and the allowable limit may be set to a maximum allowable pressure and a maximum allowable force that can be endured for each part of a human body.

In the above, the robot 100 and the robot system according to one embodiment of the present disclosure have been described with reference to FIG. 2, but the present disclosure is not limited thereto, and the present disclosure may be applied to various robots based on international standards (ISO 10218-1, ISO 10218-2, ISO TS 15066, ISO 12100, ISO 13850, ISO 13855, IEC 60204-1) related to a robot and a robot system.

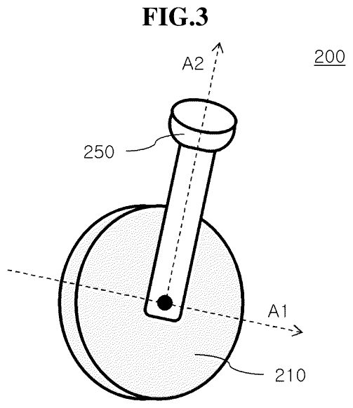

FIG. 3 is a perspective view illustrating an overall configuration of a robot end effector according to one embodiment of the present disclosure, wherein the robot end effector 200 may be attached to a robot to treat a surface of soft materials such as leather or rubber.

Referring to FIG. 3, the robot end effector 200 may be configured to include a motor 210 and a work tool 250.

The motor 210, which is a motor having a gear ratio lower than that of the motor provided in the robot, may be a quasi direct drive (QDD) motor having a low gear ratio or a direct drive (DD) motor without a gear.

For example, a motor provided in each of the joints of the collaborative robot 100 as illustrated in FIG. 2 may have a gear ratio of 50:1 to 120:1, and the motor 210 provided in the robot end effector 200 may be a QDD motor or a DD motor having a gear ratio of 10:1 or less.

The QDD motor or DD motor as described above may have high back-drivability to comply with an external force without mechanical damage even when an external force is applied while being controlled to maintain a specific position, and may have characteristics similar to a spring that returns to an original position when the external force is removed.

Additionally, an elasticity or restoring force of the QDD motor or DD motor may be adjusted by using impedance control through changing motor control parameters.

Meanwhile, a torque produced by the motor 210 may be calculated in real time by multiplying a consumption current of the motor 210 measured by a motor drive by a motor torque constant, and the lower the gear ratio of the motor 210, the higher the accuracy of the calculated torque or force.

As described above, the motor 210 provided in the end effector 200 may be implemented as a QDD motor or DD motor with a low gear ratio so as to allow the accuracy of the torque or force calculated through the motor 210 provided in the end effector 200 to be higher than that of the torque or force calculated through the motor provided in the joint of the robot 100, and accordingly, the precision and uniformity of soft material surface treatment may be improved.

The work tool 250 may be connected to the motor 210 to move by rotating according to the rotation of the motor 210, and a buffing member for roughening a surface of soft materials, such as sand paper, may be disposed at the end of the work tool 250.

Meanwhile, a rotation axis A1 of the motor 210 and a longitudinal axis A2 of the work tool 250 are configured to be orthogonal to each other, and the work tool 250 having a buffing member disposed at the end thereof may be rotated around the longitudinal axis A2.

Here, the rotation of the motor 210 and the rotation of the work tool 250 around the longitudinal axis A2 are independent of each other, and to this end, a separate motor (not shown) for rotating the work tool 250 may be provided in the end effector 200.

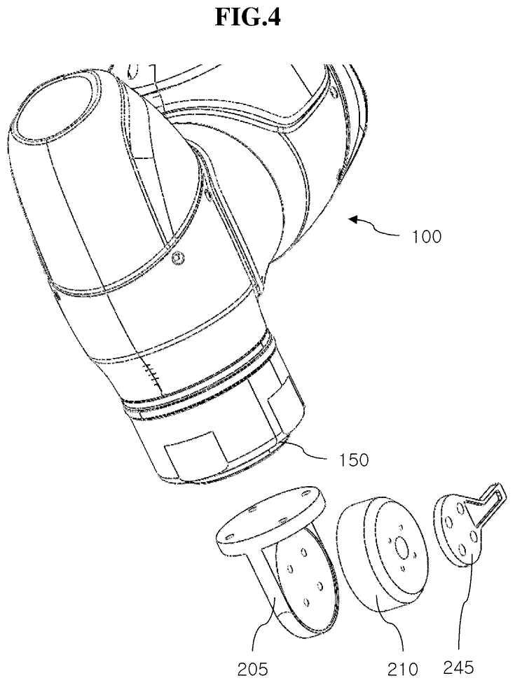

FIG. 4 illustrates a view for explaining one embodiment of a configuration of a robot end effector, wherein among the components of the illustrated end effector 200, descriptions of the same as those described with reference to FIG. 3 will be omitted.

Referring to FIG. 4, a coupler 205 of the end effector 200 may be coupled to the tool flange 150 of the robot 100.

The motor 210 may be coupled to the coupler 205 to have a rotation axis A1 orthogonal to a rotation axis of the tool flange 150.

As described above, the motor 210 may be a DD motor or a QDD motor having a gear ratio of 10:1 or less, but the present disclosure may not be limited thereto, and may include various motors having a gear ratio lower than that of the motor provided in each of the joints of the robot 100 and thus having high torque or force estimation accuracy.

Meanwhile, a work tool holder 245 may be coupled to the motor 210 to support the work tool 250 so as to allow the work tool 250 to rotate according to the rotation of the motor 210.

Here, the work tool holder 245 may be positioned so as to allow the rotation radius to meet a rotation axis, which is a center of the tool flange 150, thereby eliminating an offset between the center of the tool flange 150 and a working point of the work tool 250.

Although not illustrated in FIG. 4, the end effector 200 may be provided with a controller (not shown) for controlling a torque or force of the motor 210 to maintain a preset range based on a current consumption of the motor 210.

For example, the controller may measure a consumption current of the motor 210 through a motor drive, calculate an estimated torque of the motor 210 based on the measured current, and control, when a torque difference value between the calculated estimated torque and the set torque is greater than a threshold value, the motor 210 so as to allow the torque difference value to be compensated.

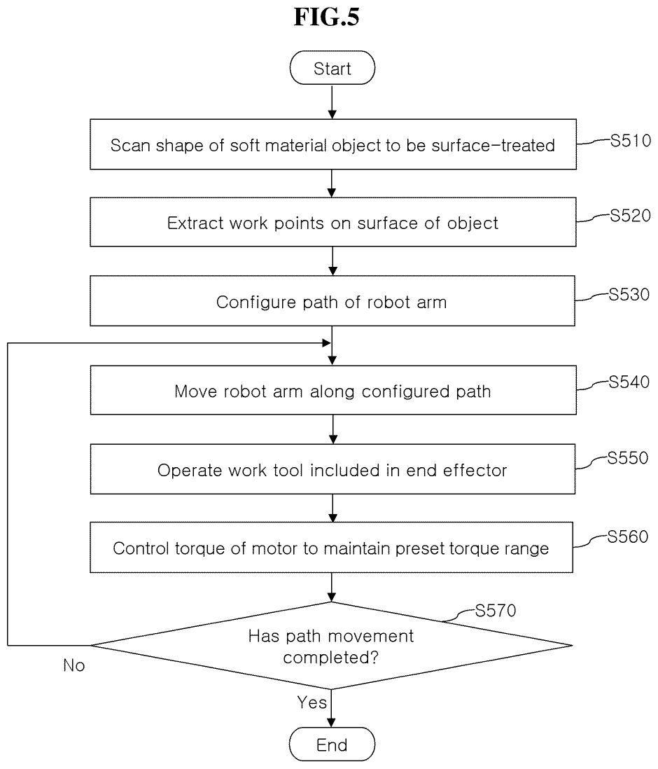

Hereinafter, with reference to FIGS. 5 to 9, embodiments of a robot control method according to the present disclosure will be described in more detail.

FIG. 5 is a flowchart illustrating a robot control method according to one embodiment of the present disclosure, which shows a method of controlling, by a robot (or robot system), a robot arm for surface treatment and the end effector 200 attached thereto.

Referring to FIG. 5, the robot scans a shape of a soft material object to be surface-treated (step S510) and extracts work points on a surface of the scanned object (step S520).

To this end, the robot may be provided with a 3D vision camera for scanning a three-dimensional shape of an object to extract work points for performing surface treatment on a surface of an object scanned through the 3D vision camera.

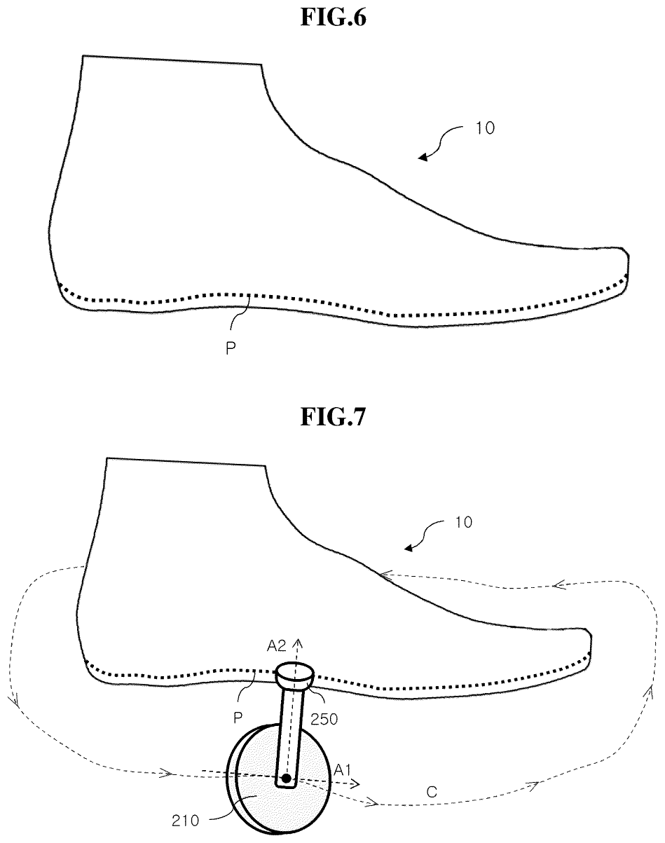

For example, as illustrated in FIG. 6, shape information of the shoe upper 10 on which buffing work is to be performed may be acquired through a 3D vision camera to calculate position coordinates of work points Ps on which the buffing work is to be performed on a surface of the shoe upper 10.

Meanwhile, the 3D contour of the object can be precisely extracted from point cloud data acquired by a 3D scanner in step S510, and based on this, an optimal path considering the robot's working characteristics can be generated.

For example, in step S510, a data acquisition and filtering process may first be performed to acquire 3D point cloud data for the sole of a shoe using the 3D scanner, set a region of interest (ROI) where the actual buffing work will be performed, and filter only the point cloud data of the region of interest (ROI).

Next, a contour extraction process can be performed, in which principal component analysis (PCA) is performed on the filtered point cloud data to align the data's main axes, the aligned 3D data is projected onto a 2D plane, and then the contour is finally extracted using an algorithm such as Alpha-shape.

Consistent result data can be obtained regardless of the pose of the shoe sole by using the data normalization process based on principal component analysis (PCA), and even concave shapes can be precisely recognized by using algorithms such as Alpha-shape.

Then, a waypoint & orientation generation process can be performed to generate N work points along the contour extracted in the contour extraction process, and determine the work direction (X, Y, Yaw) of the robot tool according to the direction of the normal vector perpendicular to the contour for each work point.

By performing the waypoint and orientation generation process described above, the buffing tool can be controlled to always approach the sole surface at an optimal angle.

The robot configures a path of the robot arm based on the extracted work points (step S530).

Here, the path of the robot arm can be configured such that a longitudinal vector of the work tool 250 and a normal vector of the work point can be orthogonal to each other, and the rotation axis of the motor 210 and the normal vector of the work point can be orthogonal to each other for the work points extracted in step S520.

For example, as illustrated in FIG. 7, an end of the work tool 250 can come into contact with the work points Ps positioned on a surface of the upper 10, and a movement path C of the motor 210 may be calculated such that the longitudinal axis A2 of the work tool 250 and the normal vector of the work point are orthogonal to each other while at the same time the rotation axis A1 of the motor 210 and the normal vector of the work point are also orthogonal to each other.

Meanwhile, a path of the robot arm (i.e., a movement of joints provided in the robot arm) can be generated so as to allow the motor 210 of the end effector 200 to move along the movement path C calculated as described above.

Also, in step S530, a path adjustment and expansion process can be performed.

In the path adjustment and expansion process, a margin can be set to apply a certain offset from the contour, depending on the size of the work tool or the process characteristics. This can allow the path to be reduced inward or expanded outward.

Furthermore, once a path is generated for one shoe (e.g., the left shoe), a symmetrical transformation can be performed to automatically generate a work path for the opposite shoe (e.g., the right shoe), thereby improving work efficiency.

When the configuring of the path of the robot arm is completed, the robot operates the work tool 250 included in the end effector 200 to treat the surface of the object (step S550) while moving the robot arm along the configured path (step S540).

First, while the robot arm moves to be positioned at a starting point of the path configured in step S530, the robot may rotate the motor 210 of the end effector 200 so as to allow the end of the work tool 250 to come into contact with one of the work points.

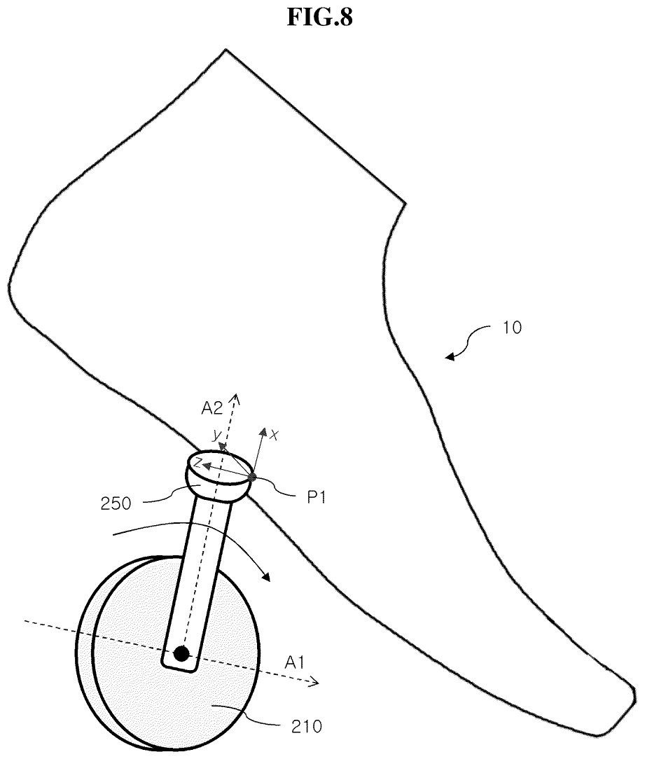

For example, as illustrated in FIG. 8, the work tool 250 of the end effector 200 may be rotated by the motor 210 so as to allow the end to come into contact with a first work point P1 on a surface of the upper 10, and allow, when coming into contact therewith, the longitudinal axis A2 of the work tool 250 and the rotational axis A1 of the motor 210 to be respectively controlled to be orthogonal to a normal vector z of the first work point P1.

While the end of the work tool 250 disposed with a buffing member such as sand paper is in contact with the first work point P1 as described above, the work tool 250 may be rotated around the longitudinal axis A2 to perform buffing work on the first work point P1.

Meanwhile, the movements of the robot arm and the end effector 200 as described above may be controlled independently of each other.

While the work tool 250 is operated for surface treatment of an object in step S550, the robot controls a torque of the motor 21 included in the end effector 200 to maintain a preset torque range (step S560).

Here, step S550 may include measuring a consumption current of the motor 210, calculating an estimated torque of the motor 210 according to the measured current, comparing a torque difference value between the estimated torque and the set torque with a threshold value, and changing a torque of the motor 210 so as to allow the torque difference value to be compensated when the difference value is greater than the threshold value.

For example, the estimated torque of the motor 210 may be calculated using Equation 1 below.

$${τ}_{f} = k \cdot {i}_{f} \qquad [ Equation 1 ]$$

In Equation 1, i_{f} is a feedback current of the motor 210 measured through the motor drive, k is a motor constant, and τ_{f} is an estimated torque value of the motor 210.

Furthermore, a torque difference value between the estimated torque and the set torque of the motor 210 may be calculated using Equation 2 below.

$${τ}_{e} = {τ}_{f} - {τ}_{d} \qquad [ Equation 2 ]$$

In Equation 2, τ_{d} is a pre-planned set torque value suitable for surface treatment, and τₑ is a torque difference value obtained by subtracting a set torque value τ_{d} from an estimated torque value τ_{f} of the motor 210.

Meanwhile, when the calculated torque difference value τₑ is greater than a preset error threshold value t, a control torque value τₘ for controlling the motor 210 may be calculated as in Equation 3 below.

$$if : \vert {τ}_{e} \vert > t , {τ}_{m} = {τ}_{d} - {τ}_{e} \qquad [ Equation 3 ]$$

In Equation 3, a control torque value τₘ may be determined by subtracting a torque difference value τₑ of the motor 210 from a pre-planned set torque value τ_{d}.

Using the calculated control torque value τₘ as a motor control parameter, the motor 210 may be controlled so as to allow the end of the work tool 250 to come into contact with the first work point P1 with a constant force.

For example, the control torque value τₘ may be converted into a current value using an inverse function of Equation 1, and a torque of the motor 210 may be controlled to maintain a pre-panned set torque value τ_{d} by adjusting a current supplied to the motor 210 with the converted current value.

Meanwhile, when the torque difference value τₑ is below the preset error threshold value t, the control torque value τₘ of the motor 210 may be maintained the same as the previously planned set torque value τd as in Equation 4 below.

$$else : {τ}_{m} = {τ}_{d} \qquad [ Equation 4 ]$$

Accordingly, when a difference between the estimated torque value τ_{f} and the set torque value τ_{d} of the motor 210 is within a range of the error threshold value t, a current supplied to the motor 210 may be maintained at the previous value.

Next, steps S540 to S560 are repeatedly performed until the robot arm completes a path movement according to the path configured in step S530 (step S570).

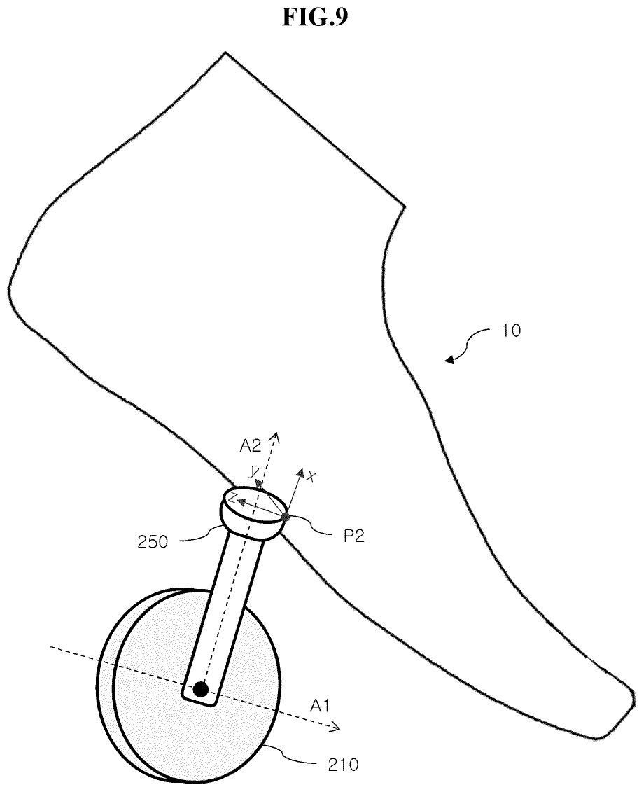

For example, subsequent to completing buffing work on the first work point P1, as illustrated in FIG. 9, the robot arm may be moved so as to allow the end of the work tool 250 to come into contact with a second work point P2, which is a next work point.

When the end of the work tool 250 comes into contact with the second work point P2, the longitudinal axis A2 of the work tool 250 and the rotational axis A1 of the motor 210 may be respectively controlled to be orthogonal to a normal vector z of the second work point P2.

While the end of the work tool 250 comes into contact with the second work point P2 as described above, the work tool 250 may be rotated around the longitudinal axis A2 to perform buffing work on the second work point P2.

While the work tool 250 is operated to perform buffing work on the second work point P2 on a surface of the upper 10, the control parameters of the motor 210 may be adjusted as described above, thereby controlling the torque of the motor 21 included in the end effector 200 to maintain a preset torque range.

When steps S540 to S560 as described above are performed for all work points extracted in step S520, an operation of the robot for surface treatment may be terminated.

As described above, a current of the motor 210 provided in the end effector 200 may be measured in real time to control a torque of the motor 210 to maintain a constant value for the work points on a surface of the object, thereby improving the precision and uniformity of surface treatment for soft materials such as leather or rubber.

Through an end effector and controlling of a force of the end effector according to the foregoing embodiment of the present disclosure, it may overcome a position information error of a robot arm path due to precision of a vision sensor, a position information error due to precision of a collaborative robot, and a position information error of the robot arm path due to coordinate conversion between the vision sensor and the collaborative robot.

In addition, the foregoing robot control method may be performed by a robot according to an embodiment of the present disclosure, but the present disclosure may not be limited thereto, and may also be performed through a separate control device.

The foregoing methods according to the present disclosure may be produced as a program to be executed on a computer and stored in a computer-readable recording medium, and examples of computer-readable recording media include a ROM, a RAM, a CD-ROM, a magnetic tape, a floppy disk, an optical data storage device, and the like.

The computer-readable recording medium may be distributed over computer systems connected via a network, and stored and executed as computer-readable codes in a distributed manner. Furthermore, functional programs, codes, and code segments for implementing the method may be easily inferred by programmers in the technical field to which the present disclosure pertains.

While the preferred embodiments of the present disclosure have been illustrated and described above, it will be of course understood by those skilled in the art that various modifications may be made without departing from the gist of the disclosure as defined in the following claims, and it is to be noted that those modifications should not be understood individually from the technical concept and prospect of the present disclosure.

What is claimed is:

1. A robot end effector attached to a robot to treat a surface of soft materials, the robot end effector comprising:
a coupler coupled to a tool flange of the robot;
a motor coupled to the coupler to have a rotation axis orthogonal to a rotation axis of the tool flange; and
a work tool connected to the motor to rotate according to the rotation of the motor,
wherein the motor has a gear ratio lower than that of the motor provided in the robot.

2. The robot end effector of claim 1, wherein the motor is a direct drive (DD) motor.

3. The robot end effector of claim 1, wherein the motor is a quasi direct drive (QDD) motor with a gear ratio of 10:1 or less.

4. The robot end effector of claim 1, further comprising:
a work tool holder coupled to the motor to support the work tool.

5. The robot end effector of claim 1, further comprising:
a controller for controlling a torque of the motor to maintain a preset torque range based on a current consumption of the motor.

6. The robot end effector of claim 5, wherein the controller measures the consumption current of the motor, calculates an estimated torque of the motor according to the measured current, and controls, when a torque difference value between the estimated torque and the set torque is greater than a threshold value, the motor so as to allow the torque difference value to be compensated.

7. A method of controlling a robot including the robot end effector of claim 1 and a robot arm to which the robot end effector is attached, the method comprising:
scanning a shape of a soft material object to be surface-treated to extract work points on a surface of the object;
configuring a path of the robot arm based on the extracted work points;
operating the work tool included in the robot end effector to treat the surface of the object while moving the robot arm along the configured path; and
controlling a torque of the motor included in the robot end effector to maintain a preset torque range while the work tool is in operation.

8. The method of claim 7, wherein the path of the robot arm is configured such that a longitudinal vector of the work tool and a normal vector of the work point can be orthogonal to each other and a rotation axis of the motor and the normal vector can be orthogonal to each other for the extracted work points.

9. The method of claim 7, further comprising:
rotating a motor of the robot end effector such that an end of the work tool comes into contact with one of the work points while the robot arm is positioned at a starting point of the configured path.

10. The method of claim 7, wherein the controlling step comprises:
measuring a consumption current of the motor;
calculating an estimated torque of the motor according to the measured current;
comparing a torque difference value between the estimated torque and the set torque with a threshold value; and
changing a torque of the motor so as to allow the torque difference value to be compensated when the difference value is greater than the threshold value.
